(19) United States
(12) Patent Application Publication
(10) Pub. No.: US 2007/0062223 A1
(43) Pub. Date: Mar. 22, 2007

(54) Optical fiber having reduced polarization mode dispersion (PMD) and method for producing the same

(75) Inventors: Jilo Paul, Trisur Dist. (IN); Kaushal Gupta, Aurangabad (IN)

Correspondence Address: James O. Ray, Jr.;Agent For Applicant(s), JAMES RAY & ASSOCIATES, 2640 Pitcairn Road, Monroeville, PA, 15146, US

(73) Assignee: STERLITE OPTICAL TECHNOLOGIES LTD

(21) Appl. No.: 11/636,140

(22) Filed: Dec. 8, 2006

(30) Foreign Application Priority Data
Oct. 16, 2006 (IN) 1712/MUM/2006

(51) Int. Cl. G02B 6/02; C03B 37/018; B32B 17/06; C03B 37/10

(52) U.S. Cl. 65/422; 385/123; 428/428; 65/428

(57) ABSTRACT

A process for producing optical fiber preform having symmetrically and completely collapsed capillary which is suitable for producing optical fiber having reduced PMD is provided, wherein collapsing of the capillary in the hollow soot porous body or sintered glass body is carried out under variable vacuum. An optical fiber preform produced by such method and optical fiber produced from such optical fiber preform are also provided.

### FIELD OF THE INVENTION

The present invention relates to optical fiber having reduced polarization mode dispersion [PMD]. Particularly, it relates to method for producing an optical fiber having reduced PMD. More particularly, it relates to a method for producing optical fiber preform having symmetrically and completely collapsed capillary, which is suitable for producing optical fiber having reduced PMD. Even more particularly, it relates to a method for producing optical fiber preform having symmetrically and completely collapsed capillary, wherein the preform produced has diameter more than about 90 mm or weight more than about 9 Kg, and is suitable for producing optical fiber having reduced PMD.

### BACKGROUND OF INVENTION

Optical fibers are inherently versatile as a transmission medium for all forms of information, be it voice, video or data. The primary object of telecommunication industry is to transmit larger amounts of information over longer distances in shorter period of time. In the recent years, certain improvements have taken place in the light carrying ability of the optical fibers.

The light carrying ability of the optical fibers for communication is primarily determined by attenuation loss and PMD. The optical losses, that is, attenuation loss in the fiber are caused by many factors including absorption loss, scattering of light, and PMD in fiber are caused by imperfect geometry of the fiber, stress and structural defects in the fiber.

It has been observed that imperfect geometry of the fiber, and stress and structural defects in the fiber are caused due to unsymmetric and incompletely collapsed centerline [capillary] in the optical fiber preform from which the fiber is drawn. The problems of imperfect geometry of the fiber, and stress and structural defects in the fiber is further enhanced if the preform from which the fiber is drawn has unsymmetric and incompletely collapsed centerline [capillary] particularly at middle portion thereof.

Therefore, the need of the time is to have an optical fiber preform which should have symmetrically and completely collapsed centerline [capillary] so that an optical fiber having reduced PMD can be produced.

The co-pending Indian patent application no. 494/MUM/2004 [IPA494] defines a process to achieve complete collapsing of the capillary of the preform, by simultaneously carrying out sintering and collapsing process steps on the dehydrated hollow soot porous body. In accordance with this method, preform having completely collapsed capillary is obtained, but the capillary in the top portion of the preform is still not completely collapsed.

The another co-pending Indian patent application no. 1530/MUM/2005 [IPA1530] defines an improved process to achieve complete collapsing of the capillary of the preform, wherein the simultaneous sintering and collapsing process steps are carried out on the dehydrated hollow soot porous body under specifically controlled heating. In accordance with this method, preform having completely collapsed capillary is obtained, particularly having collapsed capillary in the top portion of the preform.

It has been observed that both the methods taught in IPA494 and IPA1530 are suitable for achieving complete collapsing of capillary, if the preform prepared has diameter of less than about 90 mm or weight of less than about 9 Kg. However, if the preform prepared should have diameter more than about 90 mm or weight more than about 9 Kg, then both the methods taught in IPA494 and IPA1530 result in incomplete collapsing of the capillary, particularly in the middle portion.

The methods taught in IPA494 and IPA1530 do not address the problem of unsymmetric collapsing of the capillary and uncollapsed capillary at the middle portion particularly when the preform prepared is of diameter more than about 90 mm or weight more than about 9 Kg.

### NEED OF THE INVENTION

Therefore, there is a need to have a method for preparing an optical fiber preform having symmetrically and completely collapsed centerline [capillary] so that an optical fiber having reduced PMD can be produced therefrom, and to have an optical fiber having reduced PMD. Further, there is a need to have a method for preparing an optical fiber preform wherein the method is suitable even if the preform should have diameter more than about 90 mm or weight more than about 9 Kg.

### OBJECTS OF THE INVENTION

One of the main objects of the present invention is to provide a method for preparing an optical fiber preform having symmetrically and completely collapsed centerline [capillary] so that an optical fiber having reduced PMD can be produced therefrom, and to provide an optical fiber having reduced PMD.

The another main object of the present invention is to provide a method for preparing an optical fiber preform wherein the method is suitable even for producing preform of diameter more than about 90 mm or weight more than about 9 Kg.

Another object of the present invention is to provide a method for preparing an optical fiber preform having symmetrically and completely collapsed capillary, so that an optical fiber having perfect geometry and, reduced stress and structural defects can be produced therefrom, and to provide an optical fiber having perfect geometry, and reduced stress and structural defects.

Still another object of the present invention is to provide a method for preparing an optical fiber preform having symmetrically and completely collapsed capillary, particularly at and around middle portion thereof, so that an optical fiber having perfect geometry, and reduced stress and structural defects can be produced therefrom, and to provide an optical fiber having perfect geometry, and reduced stress and structural defects over its entire length.

Other objects and advantages will be apparent from the following description when read in conjunction with the accompanying figures.

### BRIEF DESCRIPTION OF THE INVENTION

It is apparent from the foregoing description that the known methods for producing preform are not suitable for producing a preform having symmetrically and completely collapsed capillary, particularly at the middle portion thereof, and having diameter more than about 90 mm or weight more than about 9 Kg, wherein the preform produced is suitable for producing optical fiber having reduced PMD.

The present inventors have observed that the collapsing of the capillary in a hollow soot porous body or sintered glass body is carried out while applying a constant vacuum along entire length of hollow soot porous body or sintered glass body. It has been observed that the collapsing of capillary under constant vacuum results in unsymmetrical and incomplete collapsing of the capillary, particularly at and around its middle portion.

As the mandrel employed in preparation of a preform has tapered diameter for achieving its easy removal from the soot porous body, the prepared hollow soot porous body and the sintered glass body prepared therefrom are observed to have reducing capillary diameter from one end [referred as top end] to another end [referred as bottom end] of the soot porous body or sintered glass body.

The present inventors have observed that the constant vacuum applied in hollow soot porous body or sintered glass body having capillary of reducing [varying] diameter from one end to another end during the collapsing process step surprisingly causes unsymmetric and incomplete collapsing of capillary, particularly at and around its middle portion while producing the optical fiber preform [mother preform]. Such optical fiber preform having unsymmetric and incompletely collapsed capillary has been observed to have imperfect geometry, non-uniform stress and structural defects at its centerline region. It has also been observed that the preform having unsymmetric and incompletely collapsed capillary meaning thereby having imperfect geometry, non-uniform stress and structural defects at its centerline region produces an optical fiber having imperfect geometry, and stress and structural defects.

It has been further observed that during the collapsing step, the hollow soot porous body or sintered glass body gets stretched, particularly at and around its middle portion primarily due to its larger weight and gravitational force. The un-symmetric stretch of the soot porous body or sintered glass body also causes unsymmetric and incomplete collapsing of capillary, particularly at and around its middle portion while producing the optical fiber preform [mother preform], which is observed to have imperfect geometry, non-uniform stress and structural defects at its centerline region. The preform having unsymmetric and incompletely collapsed capillary produces an optical fiber having imperfect geometry, and stress and structural defects.

The present inventors have surprisingly observed that if the collapsing of capillary in a hollow soot porous body or sintered glass body is carried out under a variable vacuum from one end to another end then the capillary surprisingly collapses symmetrically and completely over its entire length, including at and around its middle portion meaning thereby it produces the optical fiber preform [mother preform] having perfect geometry, and reduced stress and structural defects at its centerline region, which has been found suitable to produce an optical fiber having perfect geometry, and reduced stress and structural defects.

Accordingly, in one embodiment, the present invention relates to a method for producing optical fiber preform having symmetrically and completely collapsed capillary which is suitable for producing optical fiber having reduced PMD, comprising collapsing the capillary in the hollow soot porous body or sintered glass body under variable vacuum to form optical fiber preform having symmetrically and completely collapsed capillary.

In one embodiment, the present invention also relates to a fiber produced from the preform produced by employing method of the present invention, wherein the fiber produced has reduced PMD.

Other advantages and preferred embodiments of the present invention will be apparent from the following description when read in conjunction with the accompanying figures, which are not intended to limit scope of the present invention.

### DESCRIPTION OF THE ACCOMPANYING FIGURES

FIG. 1 illustrates a schematic representation of deposition process over a mandrel to produce a soot porous body.

FIG. 2 illustrates a schematic representation of hollow soot porous body having centerline therethrough after removal of mandrel from the soot porous body.

FIG. 3 illustrates a schematic cross-sectional view of hollow soot porous body having centerline therethrough after removal of mandrel from the soot porous body.

FIG. 4 illustrates a schematic representation of hollow soot porous body inside the sintering furnace after removal of mandrel from the soot porous body.

FIG. 5 illustrates a hollow soot porous body having centerline therethrough after removal of mandrel from the soot porous body which is subjected to steps of dehydration, and sintering and collapsing to produce a solid glass preform.

FIG. 6 illustrates vacuum profile, in accordance with one of the preferred embodiments of the present invention, for simultaneous sintering and collapsing, or collapsing process step to have symmetric and complete collapsing of the capillary to produce a solid glass preform.

FIG. 7 illustrates vacuum profile, in accordance with another preferred embodiment of the present invention, for simultaneous sintering and collapsing, or collapsing process step to have symmetric and complete collapsing of the capillary to produce a solid glass preform.

FIG. 8 illustrates vacuum profile, in accordance with still another preferred embodiment of the present invention, for simultaneous sintering and collapsing, or collapsing process step to have symmetric and complete collapsing of the capillary to produce a solid glass preform.

FIG. 9 illustrates PMD of the fiber produced in accordance with conventional method.

FIG. 10 illustrates PMD of the fiber produced in accordance with one of the preferred embodiments of the present invention.

FIG. 11 illustrates PMD distribution of the fiber produced in accordance with conventional method.

FIG. 12 illustrates PMD distribution of the fiber produced in accordance with one of the preferred embodiments of the present invention.

### DETAILED DESCRIPTION AND PREFERRED EMBODIMENTS OF THE INVENTION

Typically, a preform can be manufactured by any of the conventional method, for example by ACVD method, which is described herein for reference.

In accordance with a typical ACVD process to manufacture a soot porous body, as illustrated in accompanying FIG. 1, the preparation of soot porous body 1 comprises the following steps. The glass-forming precursor compounds are oxidized and hydrolyzed to form porous silica based materials 2. The porous silica based materials 2 are deposited on a mandrel 3, which can be any commercially available mandrel with or without any specific preparation, preferably with specific preparation to remove the contaminants therefrom which is provided with a handle rod 4 and fitted on a lathe 5 to form soot porous body 1.

During the step of deposition, the mandrel 3 is rotated in a direction as illustrated by an arrow 6 and also moved along its length with reference to burner 7 to deposit the soot particles 2 on the mandrel 3 for producing soot porous body 1. During the deposition process, the dopant chemicals for example GeCl₄ may also be deposited to form the core of the preform and later the dopant chemicals may be terminated to form clad of the preform. The amount of deposition of the clad region 11 and core region 10 is achieved to have any desired ratio diameter of clad region 11 to the diameter of core region 10 [FIG. 3].

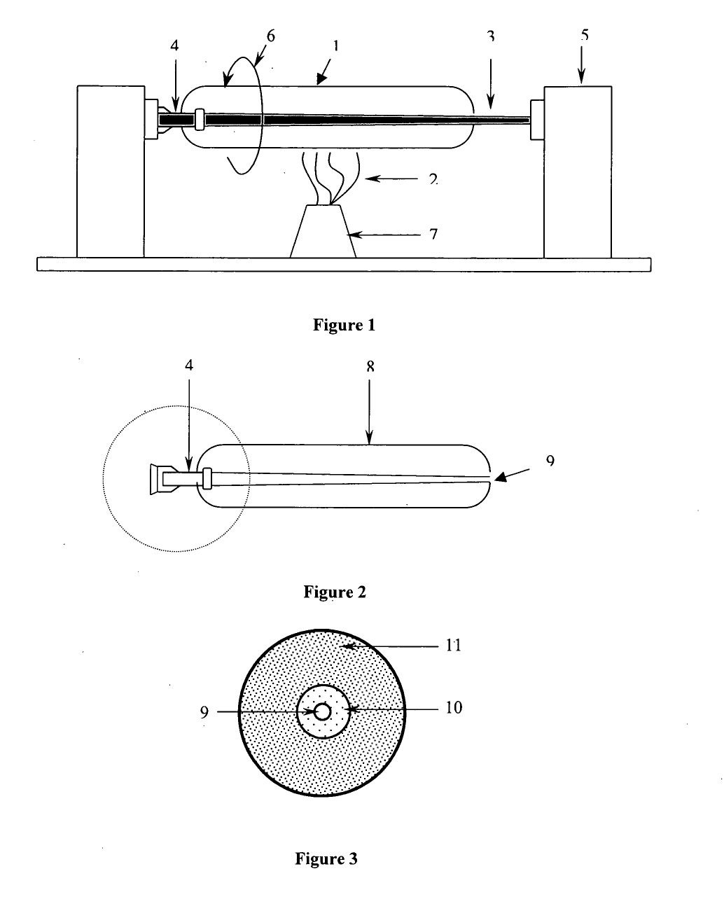

After completion of deposition, the soot porous body 1 is removed from lathe 5 along with mandrel 3 and handle rod 4, and the mandrel 3 is removed/detached, during the mandrel removal step, from the soot porous body 1 thereby resulting in formation of a hollow cylindrical soot porous body 8 (herein after referred to as hollow soot porous body) having a centerline 9 therethrough [FIG. 2].

The hollow soot porous body 8 thus formed comprises a core region 10 having a centerline hole 9 and a clad region 11 of the optical fiber preform [FIG. 3], and said core region 10 has refractive index greater than that of the clad region 11.

After removal/detachment of mandrel 3 a centerline 9 is created inside the soot porous body 1.

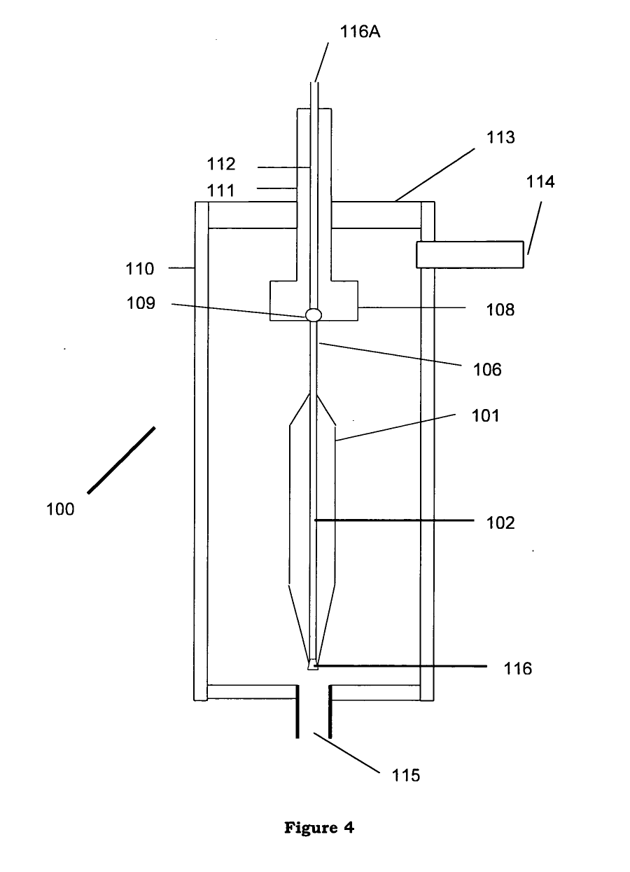

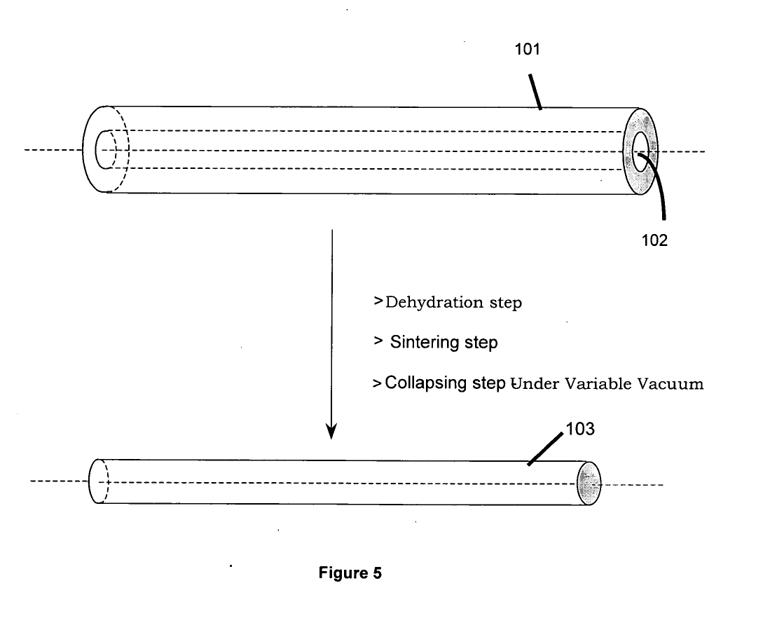

Now referring to accompanying FIG. 4, the prepared hollow soot porous body 101 is transferred to the sintering furnace 100 in order to achieve dehydration of the hollow soot porous body 101 to form dehydrated hollow soot porous body.

The dehydrated hollow soot porous body is subjected to step of sintering and collapsing [simultaneously or one after the other] of the centerline 102 to form a solid glass preform 103 [FIG. 5] with or without requiring any step of drilling or grinding or etching of the centerline 9/102 before steps of consolidation and collapsing.

Thus, the prepared hollow soot porous body 101 is dehydrated, sintered and collapsed to convert it into solid glass preform 103 [the mother preform].

In a typical embodiment of ACVD method, the hollow soot porous body 8/101, one end of which is provided with a plug 116 is inserted inside the furnace 100 with the help of the handle rod 106. The driving mechanism (not shown) facilitates lowering of the hollow soot porous body 8/101 into the furnace 100. The furnace 100 comprises a glass muffle tube 110 having a diameter sufficient to accommodate the hollow soot porous body 8/101 and to adequately provide the environment necessary for dehydration, sintering and collapsing, wherein the sintering and collapsing may either be performed simultaneously or collapsing step may be performed after sintering step. The muffle tube 110 is suitable for heating to temperatures necessary for dehydration, sintering and collapsing process steps with the heating means (not shown) which are suitably fitted to the sintering furnace 100.

The heating means selected may be suitable to create three heat zones inside the muffle tube 110 over a length. A thermocouple (not shown) provided in the furnace 100 measures the temperature of the hot zones inside the furnace created by the heating means, and the data measurement is fed to the temperature controller (not shown) that controls the temperature inside the muffle tube 110.

The furnace 100 is provided with an inlet port 115 located suitably on the furnace, preferably near the bottom of the muffle tube 110 for supplying desired gases in the muffle tube. The top end of the muffle tube 110 is suitably closed with the lid 113 to achieve the preferred temperature profile inside the muffle tube 110 and to maintain the same during the dehydration, and simultaneous sintering and collapsing process steps, and to avoid leakage of gases from the muffle tube 110 to the outside environment. A suction port 114 is suitably provided near the top of muffle tube 110 to facilitate evacuation of the gases from the muffle tube 110 as and when required or on completion of the process.

The prepared solid glass preform may optionally be reduced to form a core rod having reduced diameter, which may be overcladded by depositing soot particles to form a soot preform comprising core rod having overclad. The soot preform may be sintered in a sintering furnace to form daughter preform. The fiber may also be drawn from the daughter preform.

As described herein above, in accordance with known methods, the process step of collapsing of capillary of a hollow soot porous body, whether carried out simultaneously with sintering step or after performing the sintering step, is carried under a constant vacuum, which has been observed to result in unsymmetrical and incomplete collapsing of the capillary, particularly at its middle portion. The problem of unsymmetrical and incomplete collapsing of the capillary enhances further when the preform having diameter more than about 90 mm or weight more than about 9 Kg is required to be produced. The preform, whether mother preform or daughter preform, having unsymmetrical and incomplete collapsed capillary [centerline] has been observed to produce a fiber having increased PMD.

Therefore, the present invention aims to overcome above problems and limitations of the prior art.

Accordingly, in one embodiment, the present invention relates to a method for producing optical fiber preform having symmetrically and completely collapsed capillary which is suitable for producing optical fiber having reduced PMD, comprising collapsing the capillary in the hollow soot porous body or sintered glass body under variable vacuum to form optical fiber preform having symmetrically and completely collapsed capillary.

Accordingly, in another embodiment, the present invention relates to a method for producing optical fiber having reduced PMD from optical fiber preform having symmetrically and completely collapsed capillary which is prepared by collapsing the capillary in the hollow soot porous body or sintered glass body under variable vacuum.

In accordance with present invention, the fiber having reduced PMD may either be drawn at mother preform stage or at daughter preform stage.

It has been observed by the present inventors that if a mother preform is produced in accordance with present invention by collapsing the capillary in the hollow soot porous body or sintered glass body under variable vacuum, it has symmetrically and completely collapsed capillary, which has been found suitable to produce optical fiber having reduced PMD, and has also been found suitable to produce a daughter preform which in-turn has been found suitable to produce optical fiber having reduced PMD.

In accordance with present invention, the mother preform having symmetrically and completely collapsed capillary produced in accordance with present invention, preferably has diameter more than about 90 mm or weight more than about 9 Kg.

Accordingly, in first preferred embodiment, the present invention relates to a method for producing optical fiber preform having symmetrically and completely collapsed capillary, which is suitable for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) simultaneously sintering and collapsing the dehydrated soot porous body to collapse the capillary thereby to form mother preform;
   characterized in that the simultaneous sintering and collapsing steps on dehydrated soot porous body to collapse the capillary and to form mother preform is carried out under variable vacuum.

Accordingly, in second preferred embodiment, which is extension of first embodiment, the present invention relates to a method for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) simultaneously sintering and collapsing the dehydrated soot porous body to collapse the capillary thereby to form mother preform;
vi) drawing the fiber from the mother preform;
   characterized in that the simultaneous sintering and collapsing steps on dehydrated soot porous body to collapse the capillary and to form mother preform is carried out under variable vacuum.

Accordingly, in third preferred embodiment, which is extension of first embodiment, the present invention relates to a method for producing optical fiber preform having symmetrically and completely collapsed capillary, which is suitable for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) simultaneously sintering and collapsing the dehydrated soot porous body to collapse the capillary thereby to form mother preform;
vi) reducing the diameter of the mother preform to form a core rod having reduced diameter;
vii) overcladding the core rod having reduced diameter to form soot preform comprising soot porous body having core rod;
viii) sintering the soot preform to form a daughter preform;
   characterized in that the simultaneous sintering and collapsing steps on dehydrated soot porous body to collapse the capillary and to form mother preform is carried out under variable vacuum.

Accordingly, in fourth preferred embodiment, which is extension of third embodiment, the present invention relates to a method for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) simultaneously sintering and collapsing the dehydrated soot porous body to collapse the capillary thereby to form mother preform;
vi) reducing the diameter of the mother preform to form a core rod having reduced diameter;
vii) overcladding the core rod having reduced diameter to form soot preform comprising soot porous body having core rod;
viii) sintering the soot preform to form a daughter preform;
ix) drawing the fiber from the daughter preform;
   characterized in that the simultaneous sintering and collapsing steps on dehydrated soot porous body to collapse the capillary and to form mother preform is carried out under variable vacuum.

Accordingly, in fifth preferred embodiment, the present invention relates to a method for producing optical fiber preform having symmetrically and completely collapsed capillary, which is suitable for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) sintering the dehydrated soot porous body to form sintered glass body;
vi) performing collapsing step on sintered glass body to collapse the capillary thereby to form mother preform;
   characterized in that the collapsing step on sintered glass body to collapse the capillary and to form mother preform is carried out under variable vacuum.

Accordingly, in sixth preferred embodiment, which is extension of fifth embodiment, the present invention relates to a method for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) sintering the dehydrated soot porous body to form sintered glass body;
vi) performing collapsing step on sintered glass body to collapse the capillary thereby to form mother preform;
vii) drawing the fiber from mother preform;
   characterized in that the collapsing step on sintered glass body to collapse the capillary and to form mother preform is carried out under variable vacuum.

Accordingly, in seventh preferred embodiment, which is extension of fifth embodiment, the present invention relates to a method for producing optical fiber preform having symmetrically and completely collapsed capillary, which is suitable for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) sintering the dehydrated soot porous body to form sintered glass body;
vi) performing collapsing step on sintered glass body to collapse the capillary thereby to form mother preform;
vii) reducing the diameter of the mother preform to form a core rod having reduced diameter;
viii) overcladding the core rod having reduced diameter to form soot preform comprising soot porous body having core rod;
ix) sintering the soot preform to form a daughter preform;
   characterized in that the collapsing step on sintered glass body to collapse the capillary and to form mother preform is carried out under variable vacuum.

Accordingly, in eighth preferred embodiment, which is extension of seventh embodiment, the present invention relates to a method for producing optical fiber having reduced PMD, comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) sintering the dehydrated soot porous body to form sintered glass body;
vi) performing collapsing step on sintered glass body to collapse the capillary thereby to form mother preform;
vii) reducing the diameter of the mother preform to form a core rod having reduced diameter;
viii) overcladding the core rod having reduced diameter to form soot preform comprising soot porous body having core rod;
ix) sintering the soot preform to form a daughter preform;
x) drawing the fiber from daughter preform;
   characterized in that the collapsing step on sintered glass body to collapse the capillary and to form mother preform is carried out under variable vacuum.

As stated herein above, in accordance with present invention, the mother preform having symmetrically and completely collapsed capillary produced in accordance with present invention, preferably has diameter more than about 90 mm or weight more than about 9 Kg.

In accordance with present invention, the variable vacuum is varied from bottom end to top end of the soot porous body [referred as body] based on part of the soot porous body or sintered glass body being collapsed.

In accordance with present invention, the vacuum for X length of soot porous body or sintered glass body is different in its bottom part, ramp down part, middle part, ramp up part and top part.

In accordance with preferred embodiment of the present invention, the vacuum inside the body is varied in the range varying from about 130 to about 160 torr while collapsing the bottom portion of the body.

The vacuum inside the body is reduced from a range of about 130 to about 160 torr in the bottom portion to a range varying from about 170 to about 190 torr while collapsing ramp down portion of the body.

The vacuum inside the body is varied in the range varying from about 170 to about 190 torr while collapsing middle portion of the body.

The vacuum inside the body is increased from a range of about 170 to about 190 torr in the middle portion to a range varying from about 15 to about 5 torr while collapsing ramp up portion of the body.

The vacuum inside the body is varied in the range varying from about 15 to about 5 torr while collapsing top portion of the body.

In accordance with preferred embodiment of the present invention for X length of soot porous body or sintered glass body the length of bottom part of the body varies from about 0X to about 0.36 X.

For X length of soot porous body or sintered glass body the length of ramp down part of the body varies from about 0.36 X to about 0.42 X.

For X length of soot porous body or sintered glass body the length of middle part of the body varies from about 0.42 X to about 0.79 X.

For X length of soot porous body or sintered glass body the length of ramp up part of the body varies from about 0.79 X to about 0.88 X.

For X length of soot porous body or sintered glass body the length of top part of the body varies from about 0.88 X to 1X.

In accordance with particular embodiment of the present invention, for X length of the body, the vacuum inside the hollow soot porous body or sintered glass body is varied in different portions based on the portion [part] of the soot porous body or sintered glass body being collapsed in following manner:—
The vacuum inside the hollow soot porous body is varied in the range varying from about 130 to about 160 torr while collapsing the bottom portion of the soot porous body or sintered glass body;
The vacuum inside the hollow soot porous body is reduced from a range of about 130 to about 160 torr in the bottom portion to a range varying from about 170 to about 190 torr while collapsing ramp down portion of the soot porous body or sintered glass body;
The vacuum inside the hollow soot porous body is varied in the range varying from about 170 to about 190 torr while collapsing middle portion of the soot porous body or sintered glass body;
The vacuum inside the hollow soot porous body is increased from a range of about 170 to about 190 torr in the middle portion to a range varying from about 15 to about 5 torr while collapsing ramp up portion of the soot porous body or sintered glass body;
The vacuum inside the hollow soot porous body is varied in the range varying from about 15 to about 5 torr while collapsing top portion of the soot porous body or sintered glass body;
   wherein the length of bottom portion (part) of the soot porous body or sintered glass body varies from about 0.32 X to about 0.36 X, the length of ramp down portion (part) of the soot porous body varies from about 0.36 X to about 0.42 X, the length of middle portion (part) of the soot porous body varies from about 0.42 X to about 0.79 X, the length of ramp up portion (part) of the soot porous body varies from about 0.79 X to about 0.88 X, and the length of top portion (part) of the soot porous body varies from about 0.88 X to 1X.

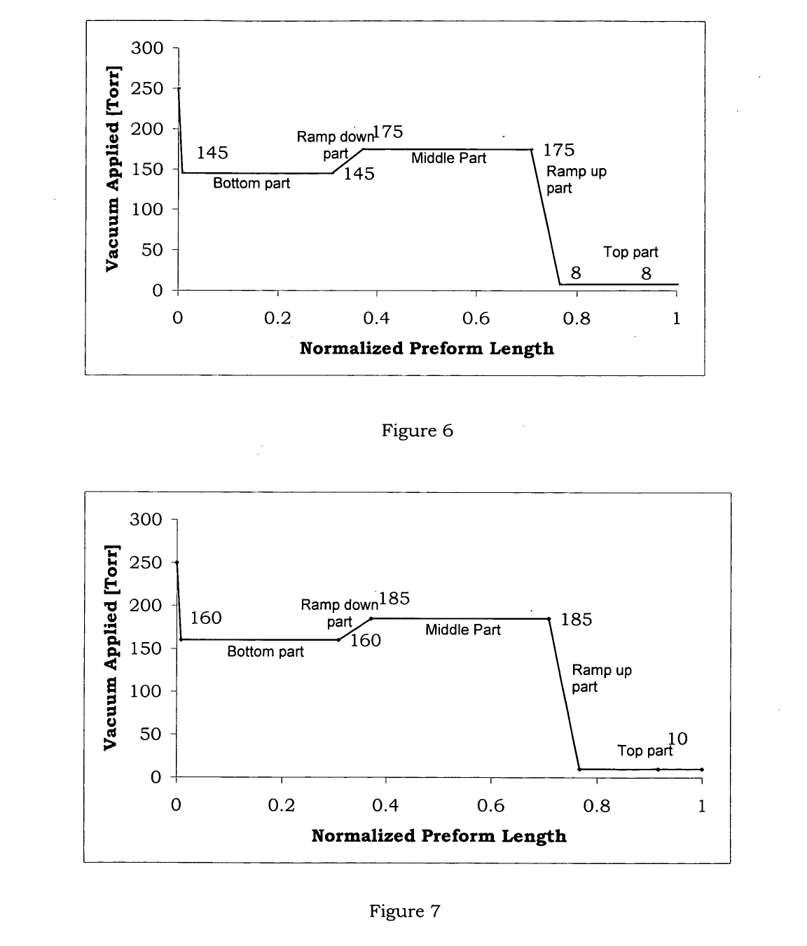

In accordance with one of the preferred embodiments of the present invention, the vacuum profile for process step of collapsing, whether simultaneously or preceded by sintering step, is shown in accompanying FIG. 6.

In accordance with another preferred embodiment of the present invention, the vacuum profile for process step of collapsing, whether simultaneously or preceded by sintering step, is shown in accompanying FIG. 7.

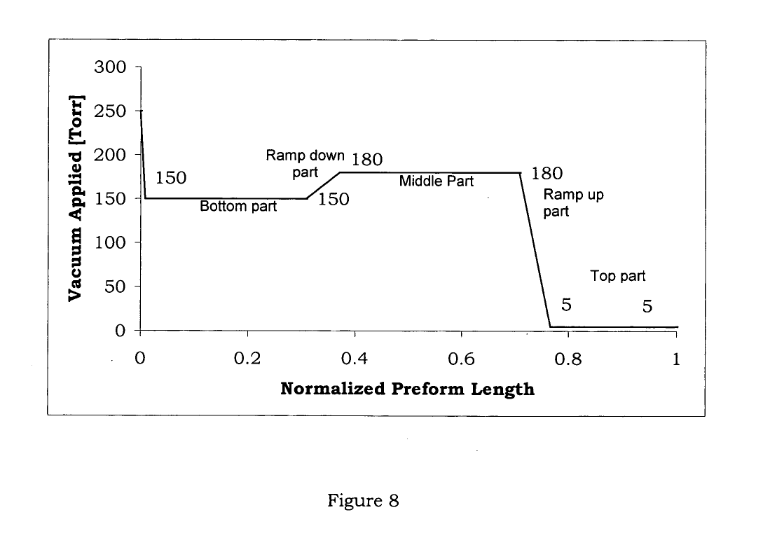

In accordance with still another preferred embodiment of the present invention, the vacuum profile for process step of collapsing, whether simultaneously or preceded by sintering step, is shown in accompanying FIG. 8.

In one embodiment, the present invention relates to an optical fiber preform having symmetrically and completely collapsed capillary when produced in accordance method of the present invention.

In another embodiment, the present invention relates to a method for producing optical fiber having reduced PMD from optical fiber preform which is produced in accordance method of the present invention.

In still another embodiment, the present invention relates to an optical fiber having reduced PMD when produced in accordance with present invention.

It has been observed that optical fiber preform having symmetrically and completely collapsed capillary prepared in accordance with present invention does not show any seeds or bubbles, and hence, no breakage of fiber has been observed during the fiber draw process step.

It has also been observed that optical fiber preform having symmetrically and completely collapsed capillary prepared in accordance with present invention shows reduced core ovality in the optical fiber produced from such preform.

It is apparent from the foregoing description that the presently disclosed method has overcome disadvantages, limitations and drawbacks of the prior art.

It may be noted that various terms, for example mandrel, soot porous body, hollow soot porous body, capillary, dehydrated soot porous body, sintered glass body, solid glass preform, core rod having reduced diameter, soot porous body having core rod, core rod, mother preform, soot preform, daughter preform, sintered core rod, bottom portion, ramp down portion, middle portion, ramp up portion etc. as employed herein are merely intended to illustrate the present invention and are not intended to restrict scope of the present invention. It is obvious for the persons skilled in the art that alternative terms may also be employed to describe the present method without deviating from the intended scope of the present invention.

It may also be noted that the presently disclosed method has been described with reference to ACVD method. However, the present method is suitable even for other alternative methods known for producing mother preform and daughter preform.

The present invention is now elaborated with the help of following examples, which are not intended to limit its scope.

### EXAMPLE 1

### Prior Art Method

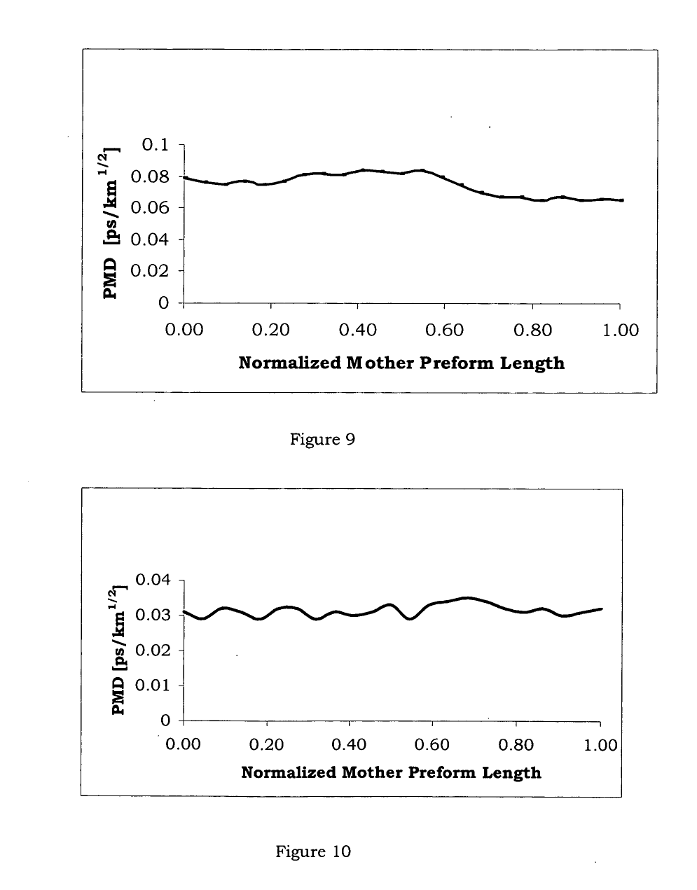

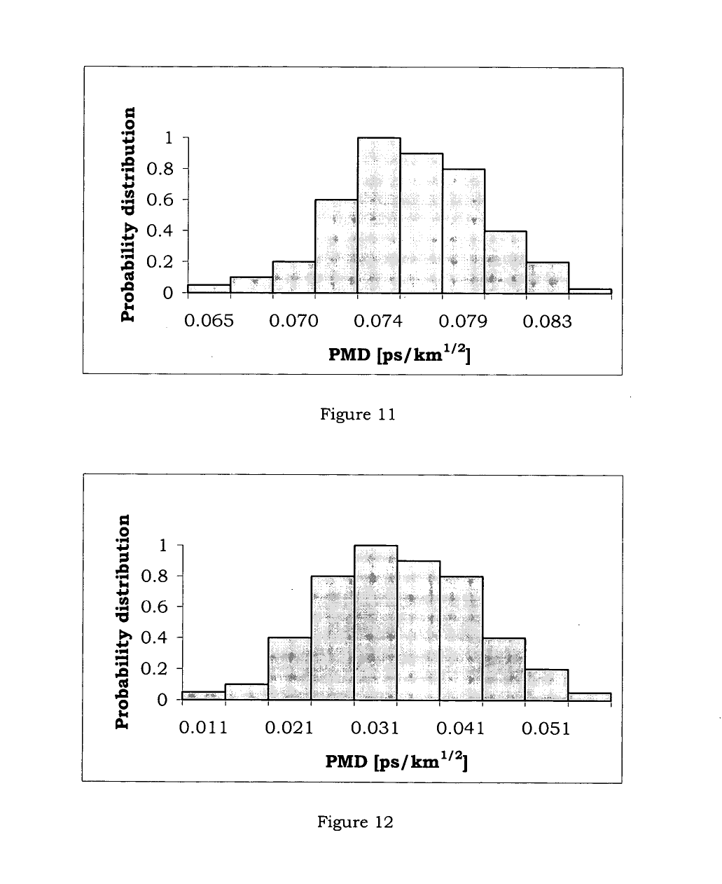

A mandrel having tapering from one end to other was fixed in a deposition lathe with the help of a handle. The soot particles were deposited onto the mandrel while rotating, by employing ACVD method, to form core and clad of the preform. During the deposition process, the dopant chemical, GeCl₄ was mixed with soot particles to form core of the preform and later, during formation of clad of the preform, the supply of dopant chemical was terminated. After deposition of approximately 9.5 kg of soot particles, the deposition was terminated and the so formed soot porous body with the mandrel was removed from the deposition lathe. The mandrel was removed from the soot porous body to form the hollow soot porous body, having a capillary therethrough, of length 120 cm [X]. A plug was inserted in the bottom end of the capillary of the hollow soot porous body to close bottom thereof. After closure of bottom end, the hollow soot porous body was hanged in a sintering furnace. The hollow soot porous body was chemically dehydrated [dried] by supplying chlorine gas with helium at a temperature of about 1050° C. The dehydrated hollow soot porous body having a capillary therethrough was then simultaneously sintered and collapsed in the same sintering furnace to cause sintering of hollow soot porous body and collapsing of capillary therein at a temperature of about 1550° C. under a constant vacuum of 125 torr to form mother preform. The mother preform thus formed was observed for stretching and formation of bubbles over its entire length. It was observed that the mother preform thus formed was stretched above half of the preform length, and bubbles formation was also observed at middle part of the preform over its length from about 0.4X to about 0.6X, wherein X indicates total length of the preform. The mother preform was then drawn into plurality of core rods of required diameter. The core rods containing the bubble portion of the preform had to be discarded resulting in wastage of production. The ovality of core rods was measured using PK2600. The core rods were found to be oval having high ovality varying from 1.5 to 2%. The refractive index profile of the core rods was also measured using a PK2600 instrument from Photon Kinetics. The refractive index profile was found to be asymmetric. The core rods without bubbles were further overcladded with soot particles and then again dehydrated and sintered. The daughter preforms thus formed were drawn into fiber in drawing tower. The polarization mode dispersion [PMD] of the drawn optical fibers was measured using commercially available instrument—Perkin Elmer model PMD 4000. The polarization mode dispersion [PMD] was mapped with respect to mother preform length. The PMD variation with respect to mother preform length is shown in accompanying FIG. 9. The PMD value variation is illustrated in accompanying FIG. 11. The typical PMD value for the optical fiber drawn was found to be 0.074 ps/km^{1/2}.

### EXAMPLE 2

### Present Method

A mandrel having tapering from one end to other was fixed in a deposition lathe with the help of a handle. The soot particles were deposited onto the mandrel while rotating, by employing ACVD method, to form core and clad of the preform. During the deposition process, the dopant chemical, GeCl₄ was mixed with soot particles to form core of the preform and later, during formation of clad of the preform, the supply of dopant chemical was terminated. After deposition of approximately 9.5 kg of soot particles, the deposition was terminated and the so formed soot porous body with the mandrel was removed from the deposition lathe. The mandrel was removed from the soot porous body to form the hollow soot porous body, having a capillary therethrough, of length 120 cm [X]. A plug was inserted in the bottom end of the capillary of the hollow soot porous body to close bottom thereof. After closure of bottom end, the hollow soot porous body was hanged in a sintering furnace. The hollow soot porous body was chemically dehydrated [dried] by supplying chlorine gas with helium at a temperature of about 1050° C. The dehydrated hollow soot porous body having a capillary therethrough was then simultaneously sintered and collapsed in the same sintering furnace to cause sintering of hollow soot porous body and collapsing of capillary therein at a temperature of about 1550° C. under a variable vacuum of 160 torr in the bottom part of the preform varying from bottom end to 0.36X of the preform length, which is varied to a vacuum of 165 to 185 torr in the ramp down part of the preform varying from 0.36X to 0.42X of the preform length, which is then varied to a vacuum of 185 torr in the middle part of the preform varying from 0.42X to 0.79X of the preform length, which is then varied to a vacuum of 185 to 10 torr in the ramp up part of the preform varying from 0.79X to 0.88X of the preform length followed by varying the vacuum to 10 torr in the top part of the preform varying from 0.88X to top end of the preform to form mother preform, wherein X indicates total length of the preform. The mother preform thus formed was observed for stretching and formation of bubbles over its entire length. The stretching was observed in upper half of the preform length, but surprisingly no bubble formation was observed over its entire length including middle part thereof varying from 0.4X to 0.6X, wherein X indicates total length of the preform. The mother preform was then drawn into plurality of core rods of required diameter. As there was no bubble formation so there was no wastage of production. The ovality of core rods was also measured using PK2600. The core rods were found to have greatly reduced ovality varying from 0.3 to 0.5%. The refractive index profile of the core rods was also measured using a PK 2600 instrument from Photon Kinetics. The refractive index profile was surprisingly found to be symmetric. All core rods were further overcladded with soot particles and then again dehydrated and sintered. The daughter preforms thus formed were drawn into fiber in drawing tower. The polarization mode dispersion [PMD] of the drawn optical fibers was measured using commercially available instrument—Perkin Elmer model PMD 4000. The polarization mode dispersion [PMD] was mapped with respect to mother preform length. The PMD variation with respect to mother preform length is shown in accompanying FIG. 10. The PMD value variation is illustrated in accompanying FIG. 12. The typical PMD value for the optical fiber drawn was found to be vary low, i.e. 0.031 ps/km^{1/2}.

It is understood from the foregoing examples, namely examples 1 and 2, that when collapsing of the capillary is carried out under variable vacuum in accordance with present method, the preform is absent of bubbles [no bubble formation is observed] and the fiber drawn from such preform is found to have greatly reduced PMD. It has also been found that the core rods obtained by present method carried out under variable vacuum have reduced ovality and have symmetric refractive profile in comparison with the capillary collapsing under constant vacuum. It has also been found that the mother preform produced in accordance with present method could be drawn into fiber without any break in drawing. It has also been found that all core rods drawn from preform produced in accordance with present method could be overcladded, dehydrated and sintered and drawn into fiber without any break in drawing.

1. A process for producing optical fiber preform having symmetrically and completely collapsed capillary which is suitable for producing optical fiber having reduced PMD, comprising collapsing the capillary in the hollow soot porous body or sintered glass body under variable vacuum.

2. A process for producing optical fiber preform having symmetrically and completely collapsed capillary comprising steps of:
i) depositing soot particles on the mandrel to prepare a soot porous body having core and clad;
ii) removing the mandrel from the soot porous body to form hollow soot porous body having capillary therethrough;
iii) inserting the plug in the bottom end of the capillary of the hollow soot porous body to close one end thereof;
iv) dehydrating the hollow soot porous body in a suitable environment to completely remove the moisture in core thereby to form dehydrated soot porous body;
v) simultaneously sintering and collapsing the dehydrated soot porous body to collapse the capillary thereby to form mother preform;
characterized in that the simultaneous sintering and collapsing steps on dehydrated soot porous body to collapse the capillary and to form mother preform are carried out under variable vacuum.

3. A process as claimed in claim 2, further comprising drawing the fiber from the mother preform produced in process step-v).

4. A process as claimed in claim 2, further comprising steps of
vi) reducing the diameter of the mother preform produced in process step-v) to form a core rod having reduced diameter;
vii) overcladding the core rod having reduced diameter to form soot preform comprising soot porous body having core rod;
viii) sintering the soot preform to form a daughter preform.

5. A process as claimed in claim 4, further comprising drawing the fiber from the daughter preform produced in process step-viii).

6. A process as claimed in claim 2, wherein said step-v) of sintering and collapsing steps is carried out in step-wise mode comprising steps of:
v) sintering the dehydrated soot porous body to form sintered glass body; and
vi) performing collapsing step on sintered glass body to collapse the capillary thereby to form mother preform,
wherein the method is characterized by performing collapsing step on sintered glass body to collapse the capillary thereby to form mother preform under variable vacuum.

7. A process as claimed in claim 6, further comprising drawing the fiber from the mother preform produced in process step-vi).

8. A process as claimed in claim 6, further comprising steps of:—
vii) reducing the diameter of the mother preform produced in process step-vi) to form a core rod having reduced diameter;
viii) overcladding the core rod having reduced diameter to form soot preform comprising soot porous body having core rod;
ix) sintering the soot preform to form a daughter preform.

9. A process as claimed in claim 8, further comprising drawing the fiber from the daughter preform produced in process step-ix).

10. A process as claimed in claim 2, wherein said mother preform has diameter more than about 90 mm or weight more than about 9 Kg.

11. A process as claimed in claim 2, wherein vacuum is varied from bottom end to top end of the soot porous body based on part of the soot porous body or sintered glass body being collapsed.

12. A process as claimed in claim 11, wherein vacuum for X length of soot porous body or sintered glass body is different in its bottom part, ramp down part, middle part, ramp up part and top part.

13. A process as claimed in claim 11, wherein vacuum inside the body is varied in the range varying from about 130 to about 160 torr while collapsing the bottom portion of the body.

14. A process as claimed in claim 12, wherein vacuum inside the body is reduced from a range of about 130 to about 160 torr in the bottom portion to a range varying from about 170 to about 190 torr while collapsing ramp down portion of the body.

15. A process as claimed in claim 12, wherein vacuum inside the body is varied in the range varying from about 170 to about 190 torr while collapsing middle portion of the body.

16. A process as claimed in claim 12, wherein vacuum inside the body is increased from a range of about 170 to about 190 torr in the middle portion to a range varying from about 15 to about 5 torr while collapsing ramp up portion of the body.

17. A process as claimed in claim 11, wherein vacuum inside the body is varied in the range varying from about 15 to about 5 torr while collapsing top portion of the body.

18. A process as claimed in claim 12, wherein the length of bottom part of the body varies from about 0X to about 0.36 X.

19. A process as claimed in claim 12, wherein the length of ramp down part of the body varies from about 0.36 X to about 0.42 X.

20. A process as claimed in claim 12, wherein the length of middle part of the body varies from about 0.42 X to about 0.79 X.

21. A process as claimed in claim 12, wherein the length of ramp up part of the body varies from about 0.79 X to about 0.88 X.

22. A process as claimed in claim 12, wherein the length of top part of the body varies from about 0.88 X to 1X.

23. An optical fiber preform as and when prepared by process as claimed in claim 2, wherein said optical fiber preform has symmetrically and completely collapsed capillary.

24. An optical fiber as and when produced from optical fiber preform as claimed in claim 23, wherein said optical fiber has reduced PMD.
